(19) United States
(12) Patent Application Publication
(10) Pub. No.: US 2016/0214715 A1
(43) Pub. Date: Jul. 28, 2016

(54) Systems, Methods and Devices for Collecting Data at Remote Oil and Natural Gas Sites

(71) Applicant: Greg Meffert, San Antonio, TX (US)

(72) Inventor: Greg Meffert, San Antonio, TX (US)

(21) Appl. No.: 15/077,165

(22) Filed: Mar. 22, 2016

Related U.S. Application Data
(63) Continuation-in-part of application No. 14/876,921, filed on Oct. 7, 2015.
(60) Provisional application No. 62/216,434, filed on Sep. 10, 2015.
(60) Provisional application No. 62/193,712, filed on Jul. 17, 2015.
(60) Provisional application No. 62/082,766, filed on Nov. 21, 2014.

(51) Int. Cl. B64C 39/02; B64D 47/08; G01S 17/88; G05D 1/00; G01N 15/06; G01W 1/00

(52) U.S. Cl. CPC B64C 39/024; G01N 15/06; G01W 1/00; G01S 17/88; G05D 1/00; B64D 47/08; G01N 2015/0693; B64C 2201/146; B64C 2201/127

(57) ABSTRACT

Systems, methods and devices are provided for detecting airborne particulates and/or gases at remote oil and natural gas sites, such as wells, and/or processing and refinery plants. One such system comprises an unmanned aerial vehicle (UAV), such as a drone aircraft, configured for aerial dispatch to the remote site and wireless connection to an external processor, cloud apparatus or the like. The UAV includes one or more on-board sensors configured to detect airborne particulates or gases, such as methane gas, hydrogen sulfide, hydrocarbons, weather conditions, ground-based elements or compounds or the like. The on-board sensors may comprise light transmitters, such as lasers, configured for transmitting light or laser pulses into the ambient environment around the remote site and detecting backscatter to detect the concentration and/or velocity vector(s) of the airborne particulates or gases. The UAV is further configured to wirelessly transmit data associated with the airborne particulates or gases to the external processor or cloud apparatus in real-time.

### CROSS-REFERENCES TO RELATED APPLICATIONS

This continuation-in-part application claims priority to and the benefit of U.S. application Ser. No. 14/876,921, filed Oct. 7, 2015, which claims priority to and the benefit of U.S. provisional application Ser. No. 62/216,434 (filed Sep. 10, 2015), U.S. provisional application Ser. No. 62/193,712 (filed Jul. 17, 2015), and U.S. provisional application Ser. No. 62/082,766 (filed Nov. 21, 2014). Each of these applications is incorporated by reference.

### FEDERALLY SPONSERED RESEARCH

Not applicable.

### BACKGROUND OF THE INVENTION

1. Field of the Invention

The present invention relates to data collection from remote locations. More specifically, the present invention is a system from collection operational data from processing and refinery plants and hydrocarbon storage tanks.

2. Description of the Related Art

Oil and natural gas wells, processing and refinery plants and storage tanks containing produced water, such as fracking fluids and others, are often located in extremely remote areas that are difficult to access and do not have adequate cell or internet coverage. Therefore, it has historically been difficult and expensive to manage all aspects of these sites in a timely and effective manner. Typically, technicians and engineers are required to make on-site inspections of each site in order to ensure that all equipment at the site are operating properly, record data from the site and to verify and/or diagnose operational abnormalities or failures. The vast number and remote locations of these sites, however, makes direct operational inspection on a regular basis extremely expensive for the companies that manage these sites.

In an attempt to mitigate these issues, some of these oil and natural gas sites have become equipped with remote transmitting units (RTUs) and/or controllers designed to collect and wirelessly transmit data from the sites to external processors, such as servers, for review and diagnosis by the operators. Indeed, the urgent need for improved data collection from these sites has led to a widespread proliferation of increasingly sophisticated RTUs, PLC transmitters and other SCADA-based (Supervisory Control and Data Acquisition) communications. However, these remote transmitter units are often still only capable of transmitting the most basic well or pump data and even those basic capabilities are often further limited by distances, weather and/or transmission ability. To improve upon the latter issue, cellular or other modem-based communication systems may be used in conjunction with the remote transmitting units.

However, this option is extremely expensive to fully implement and, in some cases, not even a viable option in many of the remote areas where these oil and gas sites are located.

Another drawback with current methods of collecting and transmitting data from these remote locations is that the type of data that can be transmitted is limited. For example, many operational issues or failures can only be truly diagnosed or verified through visual inspection of certain portions of the well site. Existing transmitter units are unable to capture still images or standard or enhanced video around the well site and transmit these images to operators external to the site. In addition, many other operational issues or failures require sophisticated detection methods such as detecting airborne particulates in the ambient environment of a well site (e.g., hydrogen sulfide and/or hydrocarbons) or recording sounds from the well pump to determine its operational status. These detection methods currently require an operator to by physically present at the site.

A particularly urgent problem with natural gas sites is the leakage of methane gas into the ambient environment. There are currently thousands of natural gas sites in the United States alone. Many of these sites have old equipment and piping that have been subjected to enormous wear and tear, particularly at sites where the new fracking technology has greatly expanded the area being drilled. As a consequence, methane gas leaks have unfortunately become quite common at these sites. These leaks cost millions of dollars in lost gas revenue and present a widespread human health hazard. Moreover, methane is a greenhouse gas 84 times more potent than carbon dioxide over a timeframe of 20 years. Thus, methane leakage can actually cause more damage to the ozone layer than carbon, making this growing problem a potential disaster for the earth's climate. Although natural gas releases half as much carbon as coal when burned, these leaks erode much of that advantage. Small leaks across the country add up to an estimated eight million tons of annual methane emission; having the same climate impact as the annual emissions from 160 coal plants during the next two decades.

Current methods of detecting methane gas leakage are inadequate. Methane gas sensors are often expensive and cumbersome and suffer the same challenges of other data collection systems at these remote sites; the inability to quickly and inexpensively transmit critical information to the operators of the site. Thus, the time lost between the start of the leak and the detection can result in large volumes of methane gas being released into the surrounding environment (and ultimately into the ozone layer) before the operators are even aware that a problem exists. Moreover, these methane leaks can occur at any point in the oil and gas system: at production sites, processing plants, along pipelines and in the many small and large storage facilities scattered across the country. Current methane gas sensors are generally limited to detecting gas in their immediate surroundings. Thus, it is impractical to install methane gas sensors in all areas of the oil and gas system that may be subject to leaks.

Yet another drawback with current systems for managing gas and oil sites is that they are unable to immediately respond to, and/or mitigate, potential or actual failures of equipment at the site.

To the limited extent that current systems are capable of transmitting operational failure data to a central collection location, there are no effective systems and methods for making operational changes at the site remotely. For example, if a failure status has reached a critical level that requires equipment to be immediately turned off or otherwise adjusted to limit or prevent damage occurring at the well site, an operator is required to drive to the site and physically turn off the equipment.

For these and other reasons, systems and methods are needed to remotely and cost-effectively gather more complete data from oil and natural gas well sites, refineries and/or remote fluid storage tanks.

### SUMMARY OF THE INVENTION

The present invention provides systems, methods and devices for detecting particulates, molecules, gases, ground based elements or compounds, or weather conditions at remote locations, such as oil and natural gas wells, processing and refinery plants, storage tanks for fluids, such as produced or recycled water, gas, oil or water pipelines, nuclear reactors, coal mines, windmill farms, manufacturing production lines, research stations and the like. A system according to the present invention comprises a UAV, such as a drone aircraft, and an external processor, such as a server or cloud apparatus. The UAV is configured to move to and around the remote location and comprises one or more sensors configured to detect particulates or gases in the ambient environment, such as methane gas, hydrogen sulfide (H2S), sulfur dioxide (SO2), phosphine (PH3), arsine (AsH3), ammonia (NH3), hydrogen cyanide (HCN), oxygen, carbon dioxide, carbon monoxide, hydrocarbons (e.g., oil), radioactive particles and the like. Alternatively or additionally, the sensors may be configured to detect certain weather conditions in the ambient environment, such as wind, precipitation (e.g., hail, rain, snow or sleet), potential or actual icing, water/moisture, storm or tornado conditions and the like. The UAV is further configured to transmit data associated with the detected particulates, gases or weather conditions to the external processor. The UAV rapidly and cost-effectively moves to one or more remote sites and gathers critical data related to such particulates, gases or weather conditions and then transmits that information to the external processor so that the operator is immediately aware of any operational failures, leaks, potential disasters or adverse weather conditions at the site.

In one aspect of the invention, the sensor(s) comprise one or more light transmitter(s) coupled to the UAV and configured to transmit light into the ambient environment surrounding the remote site. In certain embodiments, the light transmitters are lasers designed to transmit light at a specific frequency that corresponds to the molecular absorption frequency of airborne particulates or gases (i.e., the frequency in which the photons of the light beam are absorbed by the molecules of the substance). The sensor further comprises a detector for detecting and recording backscatter from the transmitted light and a software program for analyzing the backscatter to quantify the absorption of the light in the ambient environment and thus determine the presence and/or concentration of the particulate or gas. In other embodiments, the laser transmits one or more light beam(s) into the ambient environment and a detector collects the scatter from the light beam(s). A software program then analyzes the frequency shifts of the scattered light to identify the concentration or contribution of the specified particulates or gases in the ambient environment (the frequency shift induced by such scattering is unique for each molecule).

In preferred embodiments, the sensor comprises one or more lasers capable of transmitting multiple beams of light into the ambient environment. A first beam of light serves as a control that is tuned to a frequency that will minimize backscatter based on the ambient environment and the targeted airborne particulates or gases. The second beam of light is tuned to the frequency matching the molecular absorption frequency of the targeted particulates or gases. In these embodiments, the software program analyzes the differences between the backscatter of the first and second beams of light to determine the presence of the particulates or gases. In an exemplary embodiment, the sensor further comprises a software application capable of measuring the velocity vectors (i.e., speed and direction) of the airborne particulates or gases based on the optical Doppler effect. This enables the UAV to determine, for example, the direction and speed of wind at the remote site and/or the direction and speed of the dispersal of the airborne particulates or gases.

In other aspects of the invention, the sensor comprises a software program or application configured to vary the frequency of the transmitted light to correspond with absorption frequency(ies) of different airborne particulates or gases (e.g., changing the frequency from one that corresponds to methane to one that corresponds to hydrogen sulfide). The frequency may be manually changed by the operator while the UAV is present at the remote site, or it may be automatically changed by the software program. In these embodiments, a UAV may be capable of sensing a plurality of different airborne particulates or gases at a remote site.

In another aspect of the invention, the UAV further comprises a logic-based application configured to analyze and make decisions based on the data associated with the airborne particles or gases (or their velocity vectors) collected from the remote site. The UAV may further comprise a command software application configured to transmit GPS or navigational instructions to the flight controller of the UAV. The command software application may be part of the logic-based application or it may be a separate application coupled thereto. In certain embodiments, the command software application may instruct the UAV to move to selected locations around the remote site to further enhance the data collected at the site. For example, the UAV may be moved to various locations around the remote site to collect an average concentration of the airborne particulates or gases in the ambient environment of the site. Alternatively, the UAV may be instructed to move to a location downwind of the source of the airborne particulates or gases (e.g., a methane leak) to more accurately determine the concentration of the particulates or gases in the air and/or to determine the speed and direction of movement of these substances.

In other embodiments, the UAV will automatically transmit the data associated with the airborne particulates or gases to the external processor and wait for commands or instructions from the external processor or other user-directed action. In these embodiments, the decisions may be made by operators viewing the data from the external processor (e.g., on a computer, mobile phone or the like), or the decisions may be made automatically by the external processor. In the latter configuration, the external processor may contain their own logic-based software that are capable of making decisions based on the collected data. The system may, in fact, comprise multiple UAVs that are collecting data from one or more remote sites and transmitting this data to a central server, cloud or another UAV that correlates the data and makes decisions. For example, a plurality of UAVs may transmit data on weather conditions at remote locations around a certain region that allows the central server or cloud to correlate this data and generate an overall weather picture of the region so as to redirect flight patterns of UAVs to avoid potential or actual adverse weather conditions. Alternatively, the data may be used to allow one or more UAVs to pinpoint the source of airborne particulates or gases (e.g., a methane leak) by continuously updating the central server with concentration and velocity vector information and then moving one or more UAVs in the direction of greatest concentration and/or opposite the direction of the velocity vectors until the UAV(s) locate the source.

In another aspect of the invention, a UAV comprises one or more sensors configured to detect specific molecules located on or under the surface of the ground. In certain embodiments, these sensors comprise light transmitters, such as lasers, designed to transmit light towards the ground and to detect the backscatter of such light. The UAV further comprises a software program configured to analyze the backscattered light and to quantify a presence and/or concentration of a specific molecule located on or under the ground surface. In an exemplary embodiment, the sensors are configured to detect the presence of certain hydrocarbons, such as those found in oil, on or below the ground. The UAV comprises dispatch software configured to instruct the UAV to move close to the ground in a particular search pattern until the sensors detect the presence of such hydrocarbons.

In yet another aspect of the invention, UAV comprises one or more image capture devices configured to capture images of remote sites in multiple spectral bands. In preferred embodiments, the spectral bands include both visible and non-visible bands, such as near-infrared, red-edge, red, green, infrared and the like. Capturing images in these multiple spectral bands provides substantially more information about the remote sites than standard visible light image capture devices. For example, the multiple spectral band sensors of the present invention can be used to detect the actual or potential presence of hydrocarbons, metals or minerals on or just under the ground surface.

After the potential presence of these materials has been detected, the UAV may move closer to the detected materials and transmit a pattern of light beams from the light transmitters to confirm the presence, quantity and/or concentration of such materials. In this way, the invention provides a system and method for quickly and efficiently searching large remote areas for the presence of high-valuable substances, such as oil, natural gas, minerals or certain metals.

In a method according the present invention, a UAV moves to a remote site, detects data associated with particulates, gases, molecules or weather conditions at the remote site and wirelessly transmits that data to an external processor. Alternatively, if the UAV does not immediately have wireless access to the external processor, the UAV may store the data and transmit it when such access is available, or relay it to another UAV. In certain embodiments, the data is collected by transmitting light into the ambient environment around the remote site, collecting backscatter from the light and measuring frequency shifts of the light to identify airborne particulates, gases, molecules or weather conditions. In other embodiments, light is transmitted at a specific frequency corresponding to the absorption frequency of the airborne substances and the backscattered light is analyzed to identify those substances. In yet other embodiments, the optical Doppler effect of the backscattered light is analyzed to determine the velocity vector of particulates, molecules or gases in the air to determine the direction or speed of those substances.

In certain embodiments, the UAV analyzes the data collected at the well site and makes logic-based decisions based on the data. The UAV then generates movement instructions causing the UAV to alter its flight pattern based on such data. Alternatively, the UAV may wirelessly transmit the data to the external processor or cloud apparatus and receive GPS instructions either directly from the external processor or cloud apparatus or an operator connected thereto. For example, the UAV may be directed (i.e., automatically by itself or by an external source) to move to one or more different positions around the remote site based on either the weather data collected at the site (e.g., wind or moisture) or the data related to the specified airborne particulates or gases. In the former case, for example, the UAV may be directed to positions downwind from the remote site to determine if airborne particulates or gases have drifted away from the remote site with the wind. In the latter case, the UAV may be directed to various positions around the site to collect various readings of the presence and/or concentration of a particular substance to provide more information regarding the presence of such substance. For example, the UAV may compute an average concentration reading around the remote site of a particular substance. Alternatively, the UAV may be directed to move in the direction of higher concentration of the substance until the UAV identifies the specific location of a leak of the substance from a pipeline, storage facility or the like.

In another aspect of the invention, pluralities of UAVs are dispatched to a variety of different remote sites or areas. Each of the UAVs detects data associated with the weather conditions within its remote site or area. The data is then wirelessly transmitted back to an external processor or cloud apparatus. In certain embodiments, the external processor or cloud apparatus makes logic-based decisions related to the overall weather pattern in the remote sites or areas. For example, the external processor or cloud apparatus may redirect one or more UAVs from their original flight pattern to avoid adverse weather conditions. Alternatively, the external processor may cancel the flight of a first UAV and redeploy a second UAV to move to a particular remote site based on weather conditions between the first UAV and the remote site.

In yet another aspect of the invention, a UAV comprises one more sensors configured to detect the presence of other UAVs in the immediate area and a transmitter configured to interrupt or cease (e.g., jam) the GPS or other navigational transmissions to and from the other UAVs. Jamming the GPS transmissions will cause the software in the other UAVs to automatically default to returning the UAV to its home base.

Preferably, the UAV of the present invention comprises one or more sensors capable of detecting radio or microwave transmissions typically associated with drones or UAVs, such as transmissions from about 430 MHz to about 6 GHz. In certain embodiments, the UAV may also detect the wireless video feeds, such as HD WI FI, that are typically being transmitted by UAVs. This “geofence” system allows one or more UAVs to patrol certain areas, such as airports, stadiums, government buildings, confidential remote sites and the like, and prevent other UAVS from flying over these areas.

The novel systems, devices and methods for collecting data associated with airborne particulates, gases and/or weather conditions at remote sites according to the present invention are more completely described in the following detailed description of the invention, with reference to the drawings provided herewith, and in claims appended thereto. Other aspects, features, advantages, etc. will become apparent to one skilled in the art when the description of the invention herein is taken in conjunction with the accompanying drawings.

### BRIEF DESCRIPTION OF THE DRAWINGS

FIG. 1 is a schematic view of an unmanned aerial vehicle (UAV) according to the present invention.

FIG. 2 illustrates an exemplary image capture device on the UAV of FIG. 1.

FIG. 3 is a schematic view of the UAV of FIG. 1 collecting data from a plurality of remote sites and transmitting the data to an external processor according to a method of the present invention.

FIG. 4 is a flow diagram of a system for collecting data according to the present invention.

FIG. 5 is a flow diagram of an alternative embodiment of the system of FIG. 4 comprising a feedback control mechanism.

FIG. 6 is a flow diagram of another alternative embodiment of the system of FIG. 4 comprising one or more sensor(s) for detecting information about the ambient environment around a remote site.

FIG. 7 is a flow diagram of another alternative embodiment comprising one or more sound recording sensor(s) according to the present invention.

FIG. 8 is a flow diagram of another alternative embodiment comprising one or more flow level detector(s) for measuring fluid levels in storage tanks of remote sites.

FIG. 9 is a schematic diagram illustrating a variety of alternative external processing devices and user input devices for use with the various embodiments of the invention.

FIG. 10 is a flow diagram of a signal transmission relay system according to the present invention.

FIG. 11 is a flow diagram of a system for detecting airborne particulates, gases and/or weather conditions at a remote site according to the present invention; and

FIG. 12 is a schematic diagram of a multiple UAV system for detecting weather conditions and/or the location and concentration of particulates, molecules or gases over a plurality of remote sites.

### DETAILED DESCRIPTION OF VARIOUS EMBODIMENTS

For the purposes of promoting or understanding of the principles of the invention, reference will now be made to the embodiments, for example, illustrated in the drawings and specific language will be used to describe the same. It will nevertheless be understood that no limitation of the scope of the invention is thereby intended.

In accordance with the teachings of the present invention and as discussed in more detail presently, systems, devices and methods are provided comprising one or more unmanned aerial vehicles (UAV's) or other drone aircraft, for the purpose of collecting data from remote sites, such as oil and natural gas wells, processing and refinery plants, produced water (e.g., fracking water and the like) storage areas, windmill farms, nuclear reactors, coal mines, research stations, pipelines or other remote sites wherein cellular or other signal transmissions are limited or completely absent. In the embodiments described hereinafter, the systems and methods disclosed herein employ both the automated and user-directed dispatch of a UAV as part of a monitoring and support process for oil and natural gas wells, refineries or produced water storage areas.

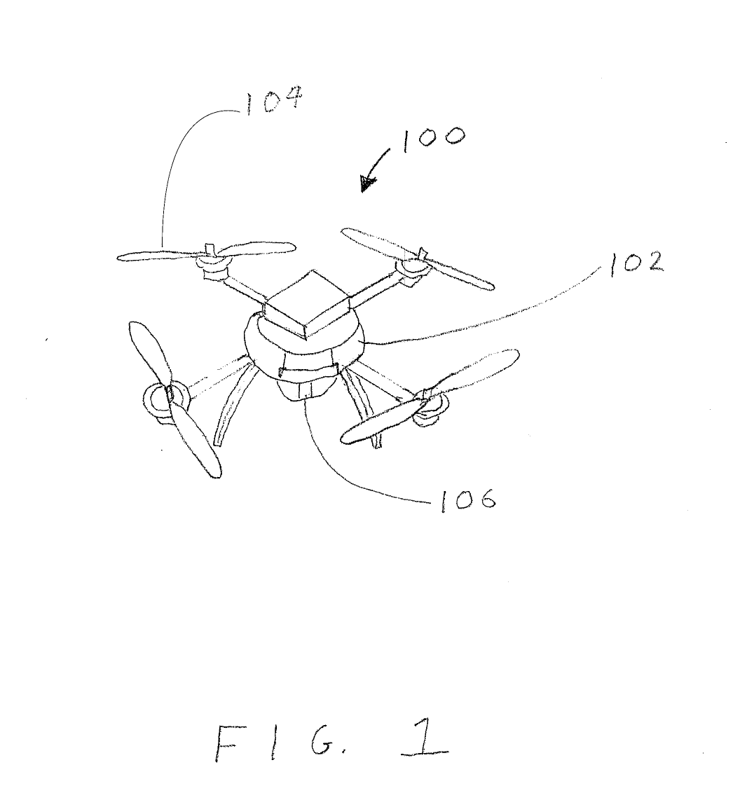

Referring now to FIG. 1, a UAV 100 according to the present invention comprises a body 102 and a plurality of rotors or propellers 104 surrounding body 102. UAV 100 will typically comprise 2-8 rotors 104 that allow UAV to move in any direction and to hover at a selected location. UAV 100 further comprises one or more motors (not shown) for driving rotors 104 and a power supply (also not shown) within body 102 for supplying power to the motor(s) and all on-board electrical systems. The power supply typically comprises one or more rechargeable batteries, such as LiPO, lithium-ion, Li, FePo, F4c, NiCad batteries and the like. Alternatively, UAV 100 may be powered by other means, such as solar power, wind power, hybrid electric-battery power, gas or other fossil fuels and the like. UAV 100 is designed to recharge its power supply at a power base 205, which may comprise a standard electrical charging pad, solar powered charging pad, gas-powered, hybrid pad or the like. The power base 205 may be located at each of the remote sites, or at a position suitably located as to allow UAV 100 to travel to the remote site(s) and back to base 205 with sufficient power to gather data at each remote site. In certain embodiments, UAV 100 may be designed to recharge wirelessly without actually being in physical contact with its base 205.

An exemplary UAV 100 that may be used in conjunction with the present invention is more fully described in the technical and operational manual for the 3D Robotics and/or Service-Drone eight rotor (or octorotor) UAV, the complete disclosure of which is hereby incorporated by reference in its entirety for all purposes. Of course, it will be understood by those of skill in the art that a variety of different types of UAV s or drones may be used in conjunction with the present invention, e.g., a DJI, Parrot Drone or other suitable UAVs known in the art. In addition, although a rotorcraft-type UAV is shown in FIG. 1, other types may be used, such as flying or fixed wing, blended wing or the like. However, rotorcraft-type vehicles are presently preferred for the present invention as they provide the ability to hover in a single location for the collection of certain data, image or video capture and the like.

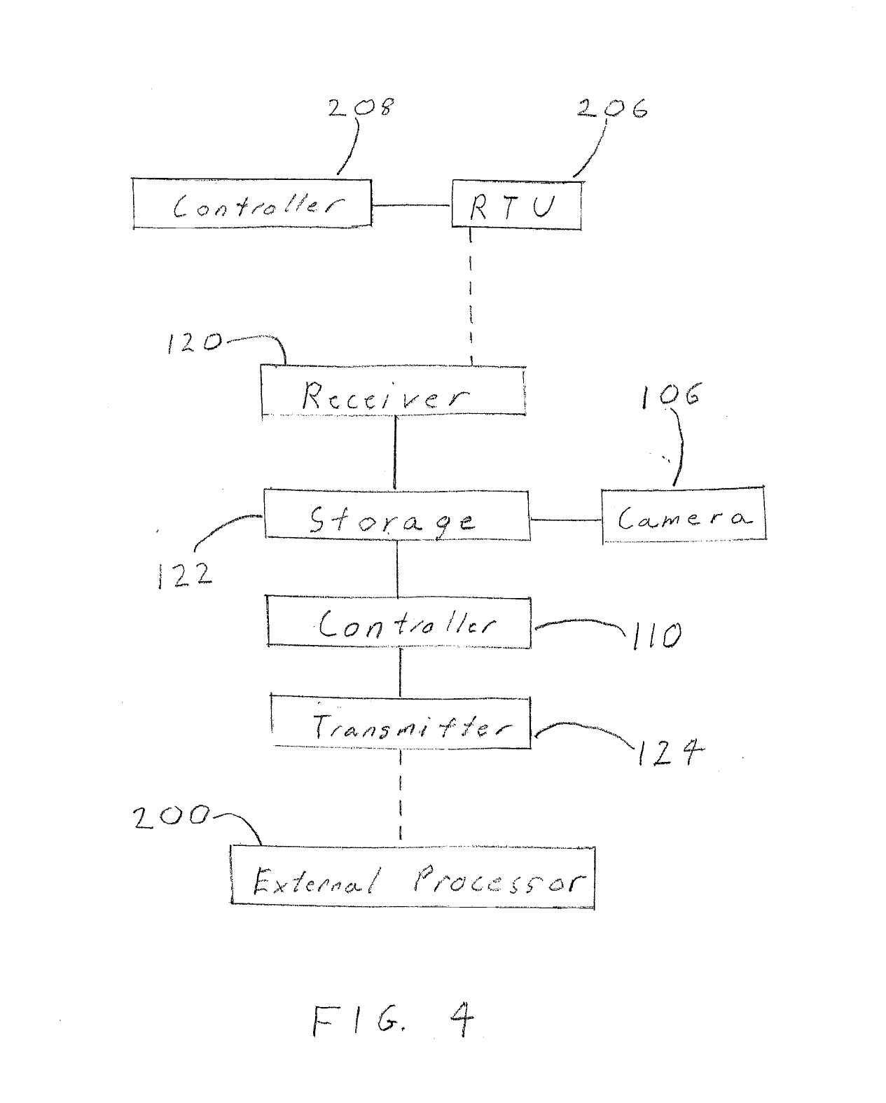

UAV 100 further comprises a flight controller 110 (see FIG. 4) which preferably includes an on-board flight computer such as the PIXHAWK® flight controller system, manufactured by 3D Robotics, Inc. of Berkeley, Calif., or other suitable flight controllers known to those of skill in the art. Flight controller 110 typically comprises flight navigation software, autopilot functions, such as scripting of missions and flight behavior and altitude and airspeed sensing software and may be coupled to various accelerometers, magnetometers, IMIJ compasses, GPS or other geo-coded sensors, airspeed sensors, altimeters, temperature and barometric pressure sensors as well as other environmental sensors to facilitate directional control of UAV 100 either directly by an external processor (not shown in FIG. 1) or through an autopilot program that delivers GPS or other geo-coded instructions through software applications to flight controller 110.

UAV 100 preferably comprises a GPS module and a plurality of servos coupled to one or more receivers and transmitting antennas (not shown) that allow UAV 100 to automatically fly to selected locations based on input from the external processor or operator. Those of skill in the art will understand that a variety of different systems may be employed to autopilot UAV 100. In some embodiments, UAV 100 may include a transponder, such as the Sagetech XPS-TR ADS B transponder (not shown) that will allow third parties (such as air traffic control) to keep track of its location in flight. UAV 100 may also include one or more software program(s) that automatically direct UAV 100 to return to its base if, for example, the battery power runs low to avoid crashing and/or if the UAV has executed the autopilot command or program and has not received any further instructions (e.g., if the UAV is no longer receiving signal transmissions from its base). UAV 100 may also include a crash avoidance software application that overrides its autopilot software and alters its route if this route will cause UAV 100 to come too close to another flying object or man-made structure.

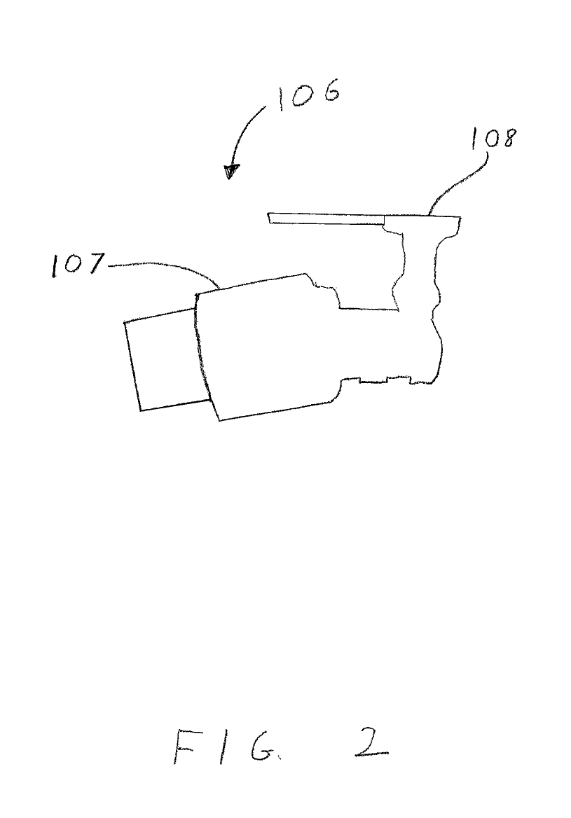

One or more video camera(s) 106 are preferably mounted to body 102 of UAV 100 to capture still and video images of the remote sites. An exemplary high-resolution video camera 106 is illustrated in FIG. 2. In one embodiment, video camera 106 has standard pan, tilt and zoom (PTZ) features. It will be recognized by those of skill in the art that a variety of commercially available video cameras may be used with the present invention, such as those manufactured by GoPro, Mobius, Contour, Sony, Keychain, Sandisk and the like. Alternatively, video camera 106 may comprise a thermal, starlight ambient, hyperspectral imaging or infrared camera for capturing images without sufficient sunlight available (i.e., at night or inclement weather), for capturing images of stress fractures in structures (e.g., in windmills) and/or for capturing thermal data at remote sites, such as storage tanks and the like. One such hyperspectral camera that is particularly suited for these purposes is the OVI-UAV-I000, manufactured by BaySpec, Inc. of San Jose, Calif. Video camera 106 is preferably mounted to a gimbal mount 108, allowing camera 106 almost 90 degrees of motion around three axes.

Video camera 106 is coupled to a digital or analog storage application 122 (see FIG. 4) of flight controller 110 or onboard computer (discussed in detail below) for storing still or video images that may be immediately uploaded and transmitted to an external processor and/or stored for transmission when UAV 100 returns to base. Video camera 106 may also include enhanced optical video wherein the video primarily comprises moving elements in a manufacturing production line that may be imaged for subsequent or immediate computer processing and analysis. Video camera 106 is also preferably coupled to the GPS module and various servos to provide location information so that UAV 100 and/or the external processor can ensure that images are captured at the desired locations around the remote site.

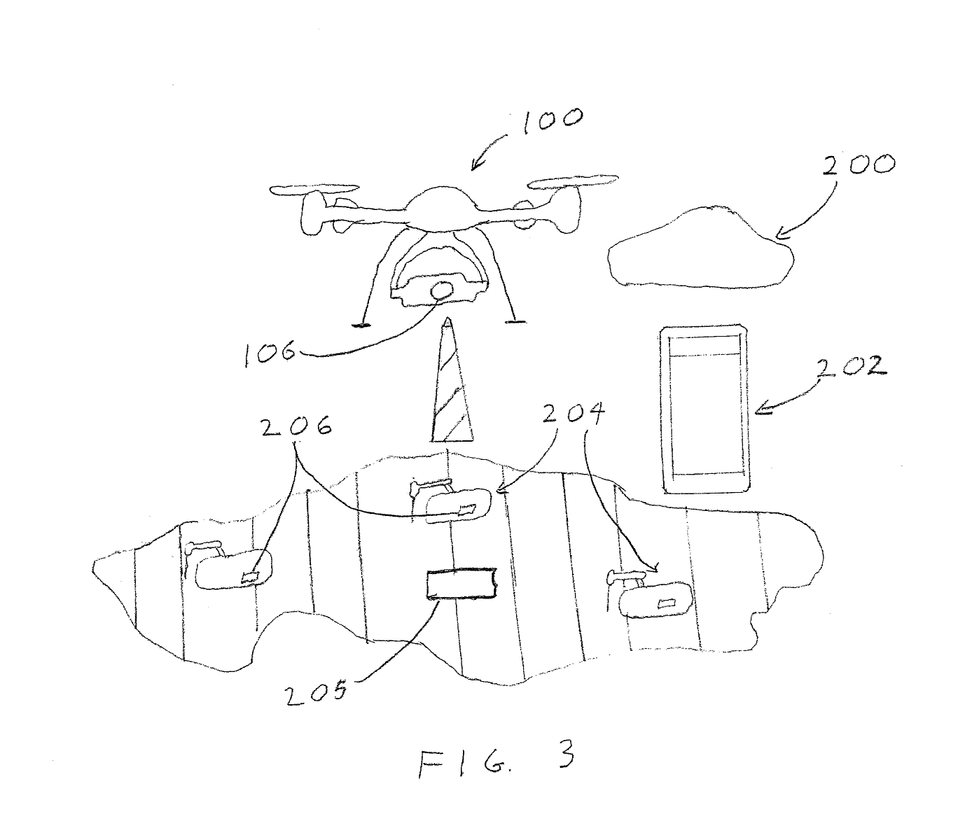

Referring now to FIG. 3, a schematic view of a system for collecting data according to the present invention is illustrated. As shown, UAV 100 comprises one or more receivers and one or more transmitters or antennas (not shown) coupled to an external processor 200, such as a telemetry cloud, SPL or other external processor via WI FI, cellular, radio, satellite, microwave or other suitable signal transmission. In one embodiment, external processor 200 comprises one or more cloud-based network server and storage devices, although it will be recognized by those skilled in the art that a variety of different types of processors with different configurations may be used in conjunction with the present invention, such as server space accessed via cloud computing apparatus and the like. External processor 200, in turn, is coupled to one or more user input devices 202, such as computers, mobile phones (e.g., Apple iPhone, iOS or Google Android-based interfaces), tablets or the like, for relaying data from UAV 100 to user input devices 202 and for transmitting instructions from the operator to UAV 100. UAV 100 and/or processor 200 preferably comprise software application(s) for consolidating and displaying the collected and collated field data from the remote sites onto user input device(s) 202.

UAV 100 may be dispatched automatically through one of a variety of computer programs, such as Drone Deploy® by Infatics, Inc. of San Francisco, Calif., ladder logic, SQL or the like, internal computer application(s) or other web-based browser user action(s) or processes, other object-based or scripting process, and/or a mobile phone or other mobile platform user action or process.

For example, a routine flying pattern of UAV 100 may be performed upon a scheduled pattern for purposes of gathering data from a plurality of remote sites 204. At the time of the automated dispatch of UAV 100 from the automated dispatch program, GPS or other geo-coded standards based location data of the remote site 204 is relayed to flight controller 110 on UAV 100. UAV 100 is then dispatched to the remote site 204 (e.g., a natural gas or oil well). In this example, UAV 100 will be directed to fly to one or more well sites 204 to perform routine daily data collection from a remote transmitter 206 and/or remote controller 208 (see FIG. 4) located at each of the well sites 204. Alternatively, UAV 100 may be dispatched on demand to a non-functioning or inadequately functioning well site.

In one embodiment, UAV 100 comprises a digital connection receiver 120 (see FIG. 4) that employs a sophisticated combination of server-based software that is configurable to allow standard SQL, ladder logic, or other “if-then” or “if-then-else” type decision-making processes to be performed against the database of remote controller 208. In addition, UAV 100 is designed to move to selected locations about each of the remote well sites 204 to perform still and video (standard or enhanced) image capture of the selected locations. The data received from remote transmitter 206 and/or remote controller 208 and the captured images from camera 106 are gathered and stored in a digital storage application 122 (see FIG. 4) within UAV 100 for subsequent and/or immediate relay and transmittal to external processor 200.

In methods of the present invention, UAV 100 is directed to a well site 204, either automatically through a decision-based computer program, or from user action via user input device 202. UAV 100 flies to a location in close enough proximity such that flight controller 110 can employ digital connection receiver 120 to establish a digital connection with one or more remote transmitters 206 at the well site 204. This connection may be one or more combinations or an industry standard WI FI or other extension of the 802.11 wireless protocol communication standard, other Internet Protocol-based (IP) networks, cellular, Bluetooth, satellite, microwave, radio or other wireless standard protocol.

UAV 100 comprises a computer application and/or system for connecting to remote transmitter 206 via one of these protocols, wherein controller 110 receives and digitally stores data from remote transmitter 206, which may comprise Modbus transmitters, PLC transmitters, RTUs, SCADA-based, or other digital or analog data broadcasters located at or near oil and natural gas sites.

In one example of operation of the present invention, UAV 100 performs daily pre-programmed surveillance of a remote well site 204 and captures images of the pump jack (not shown) at the well site. The video is uploaded through processor 200 and user input devices 202 to trained personnel for instantaneous review for abnormalities in the pump jack operation. After this review, any abnormality (e.g., pump is impaired function or has completely ceased activity) can be reported to the designated field production engineer for review via the processor cloud on his/her mobile device. After making a preliminary determination, the field engineer or operator provides instructions through processor 200 to UAV 100 to capture a close-up visual inspection at a specific location on the pump jack to confirm the suspected problem. Once this image has been captured, stored and transmitted back to the operator, he/she is able to confirm the preliminary failure analysis and dispatch personnel to fix the problem.

Referring now to FIG. 4, a schematic view of a system of the present invention is illustrated. As shown, UAV 100 comprises digital receiver 120 and camera 106 coupled to digital storage 122 and flight controller 110. Digital receiver 120 is configured to connect to remote transmitter 206 at the remote site 204 and to receive data from transmitter 206. In the embodiment, digital receiver 120 receives the data through universal WI FI, although it will be recognized that other signal transmissions are possible, such as Bluetooth, cellular, microwave, radio, satellite or the like. In some cases, remote transmitter 206 is coupled to a remote controller or computer 208 which serves to manage the data collected at the site 204 and to transmit the data to the remote transmitter 206. In other cases, transmitter 206 and controller 208 will be integral with each other (i.e., the same device) and/or the remote site 204 will not include a controller 208.

Digital storage 122 receives data from digital receiver 120 and images from camera 106 and stores these data either for immediate use by UAV 100 (discussed further below) or for transmittal to external processor 200. Digital storage 122 preferably comprises server space accessed via a cloud computing apparatus. In certain embodiments, UAV 100 does not contain digital storage 122 and data is immediately processed and then transmitted by flight controller 110. Flight controller 110 preferably comprises a processor or computer designed to run multiple software applications and to manage data flow within UAV 100. UAV 100 further comprises one or more transmitter(s) 124 coupled to flight controller 110 for transmission of data to external processor 200. Transmitter(s) 124 preferably comprise one or more antennas designed to transmit data via suitable signals, such as microwave, radio, cellular, WI FI, Bluetooth or the like. The antenna(s) may comprise an omni- or bi-directional industry standard antenna or other suitable antenna known to those of skill in the art. If a cellular or data carrier network is currently unavailable, the data may be temporarily stored on UAV 100 for later transmission through transmitter 124 when it becomes available.

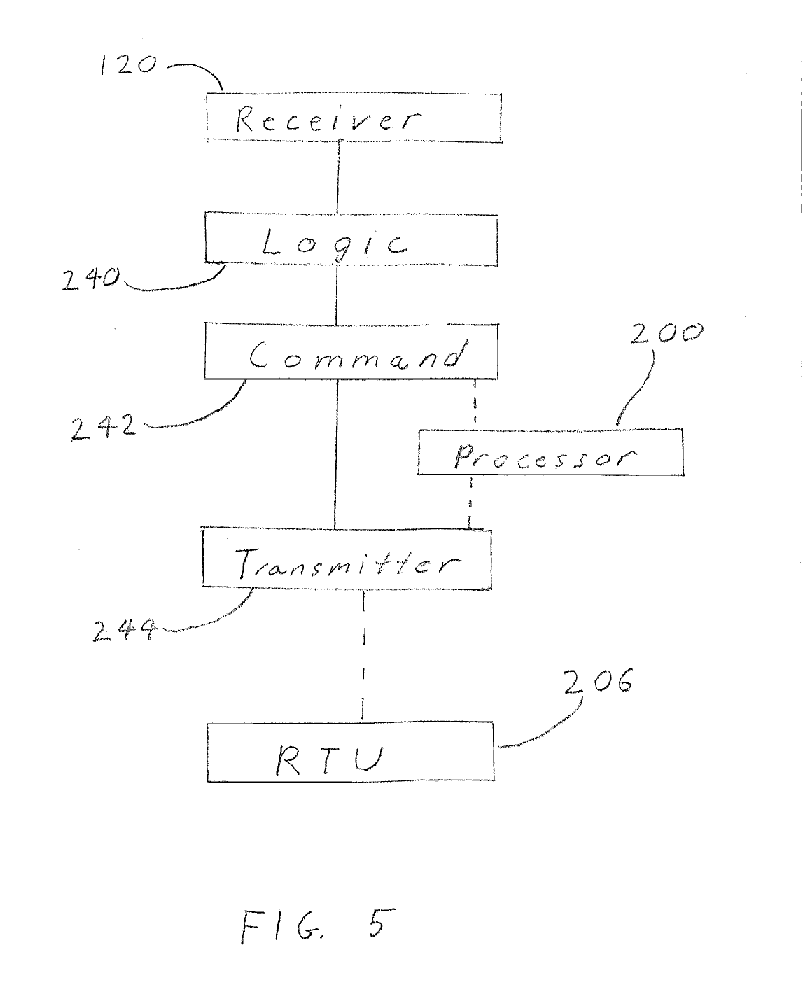

An alternative embodiment of the present invention is schematically illustrated in FIG. 5. As shown, UAV 100 comprises a decision-based logic application 240 integral with, or coupled to, flight controller 110. Logic application 240 is configured to review the collected data from the remote site and make decisions based on this data. Logic application 240 may be coupled directly to receiver 120 or it may be coupled to digital storage 122 (see FIG. 4). A command application 242 is coupled to decision-based logic application 240 and is configured to prepare data and/or instructions for transmittal by transmitter 244 to remote transmitter 208 at the site. Command application 242 may be part of logic application 240 or they may be separate software programs linked together within flight controller 110. An exemplary logic application 240 and command application 242 are DroneDeploy action software combined with custom Linux-based applications or related scripting or programming.

In this embodiment, UAV 100 provides a feedback loop that enables the system to change the operating parameters at the remote site based on the data collected there from. In one embodiment, command application 242 directly transmits instructions to remote transmitter 208, which comprises one or more receivers or antennas (not shown), for receipt of said instructions. The instructions are then relayed to controller 208 for implementation at the remote site. For example, data received from transmitter 208 may indicate that one or more pieces of equipment, such as a pump, at the well site is not operating properly and represents a safety or operating hazard to the site. In this example, logic application 240 gathers this data and makes a decision based on its programmed logic and transmits this decision to command application 242. Command application 242 then generates data or instructions based on the logic decision. The instructions may contain information causing the remote controller 208 to change the operating parameters of the equipment and/or shut the equipment down for further inspection or repair by the operator. Alternatively, the data received may indicate that certain information about the ambient environment around the remote site (e.g., airborne particulates and/or toxic gas concentrations as discussed in more detail below) is outside of operating parameters.

In an alternative embodiment, the instructions from command application 242 may simply comprise data that is transmitted to controller 208 via the receiver at the remote site. In this embodiment, controller 208 contains its own decision-based logic application (not shown) configured to make decision based on the data received from UAV 100. Thus, for example, if UAV 100 or logic application 240 makes the decision to shut down certain equipment, such as the well pump, it may transmit selected data that is received by remote transmitter 206 and read by controller 208. Controller 208 is programmed to then make the operating decision to shut down the pump based on the received data.

In another embodiment, logic application 240 and command application 242 are located at the external processor 200 instead of, or in addition to, the UAV 100. In this embodiment, UAV 100 acts to simply relay data from the remote site to external processor 200. External processor 200 then makes certain automatic decisions based on the data and issues commands, instructions or data back to UAV 100.

UAV 100 then relays these instructions to transmitter 206 and/or controller 208 at the remote site to change the operating parameters at the site. These decisions made by the external processor 200 may be made automatically based on preprogrammed software or they may be made by the operator reading the data. In the latter case, external processor 200 transmits the data to user input 202 (e.g., a mobile phone) where the operator may view or read the data and then make suitable decisions to change operating parameters at the remote site. In this case, user input 202 will comprise a software program enabling the operator to issue instructions through user input 202 to external processor 200 which, in turn, relays these instructions through UAV 100 to remote transmitter 206 at the site.

The feedback features of the present invention allow for real-time changes in operating parameters at remote sites. This has the advantage that these operating decisions will be made quickly and efficiently without requiring an operator to physically travel to the remote site.

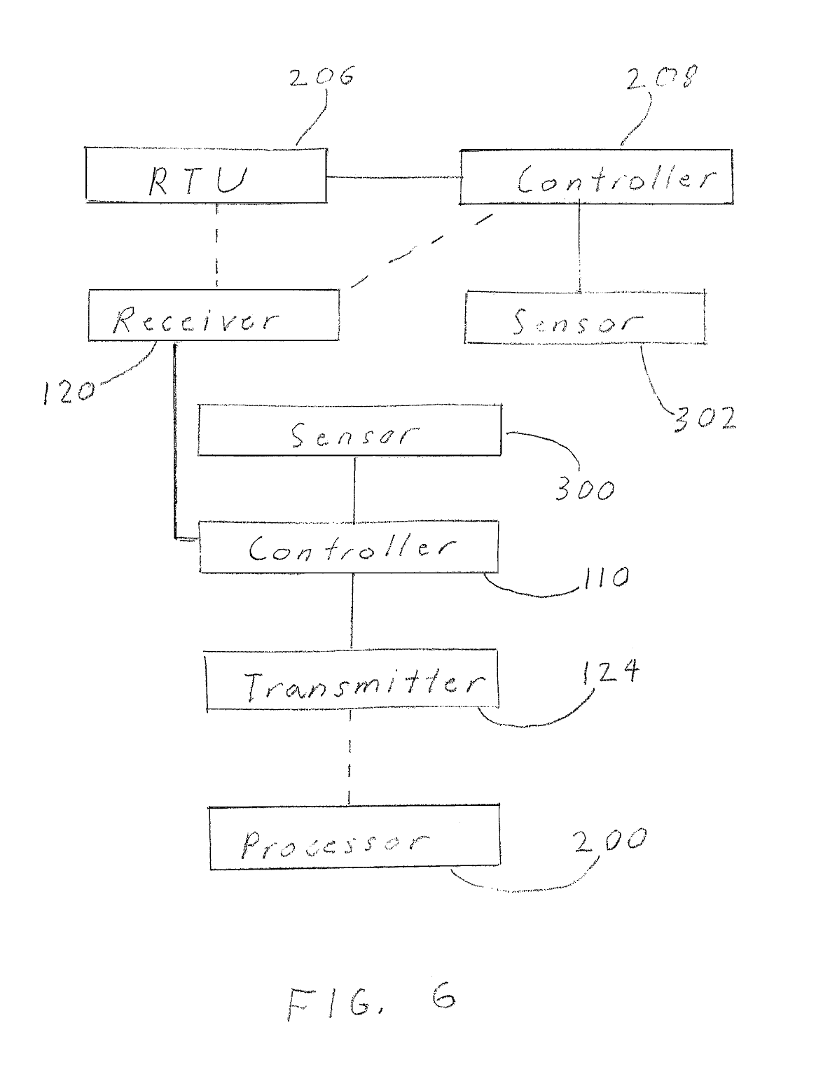

Referring now to FIG. 6, another alternative embodiment of the present invention is schematically represented. As shown, UAV 100 comprises one or more sensor(s) 300 preferably located on portions of body 102 (see FIG. 1). These sensors 300 are designed to collect data directly from the selected locations of the remote site (i.e., without the need for transmission of data from remote transmitter 206). Many oil and natural gas well sites are not currently equipped with a remote transmitter 206 or controller 208. In these cases, UAV 100 will employ sensors 300 to directly collect this data without requiring an operator to visit the site.

In one aspect of this embodiment, sensor (s) 300 comprise gas monitoring sensors designed to detect certain toxic gas concentrations and/or airborne particulates in the ambient environment around the site, such as hydrogen sulfide (H2S), arsine (AsH3), ammonia (NH3), phosphine (PH3), hydrogen cyanide (HCN), sulfur dioxide (S02), carbon monoxide (CO), methane, oxygen, carbon dioxide, hydrocarbons (e.g., oil), radioactive particles, and other combustibles or toxics. Sensor(s) 300 detect this data and transmit it to flight controller 110, which can then transmit the data to external processor 200 and/or make decisions based on the data as discussed above in reference to FIG. 5.

For example, hydrogen sulfide is often generated at oil and gas wells and the quantity of hydrogen sulfide (H2S) in the ambient environment is a sign of potential catastrophic failure of the well. Sensor(s) 300 can detect the amount of hydrogen sulfide in the air around the well site so that appropriate operating parameters can be immediately changed to either reduce the leakage, shut down the well, call an operator to respond and inspect the well or the like.

Alternatively, and/or additionally, sensor(s) 302 may be located at various locations around the remote site. In this embodiment, sensor(s) 302 are preferably coupled to remote transmitter 206 (either directly or through controller 208) such that the data detected by sensor(s) 302 can be transmitted to UAV in a similar manner as described above. Suitable gas monitoring sensors that can be used in conjunction with the present invention are the RKI MW A™ or the RKI M-Series sensors manufactured by RKI Instruments, Inc. of Union City, Calif. However, it will be recognized by those skilled in the art that other commercially available gas monitoring sensors may be used with the present invention.

In another aspect of the invention, sensors 302 are not directly coupled to either a remote transmitter 206 or a controller 208 at the remote site. In these embodiments, sensors 302 may include a transmitter (not shown) configured to transmit data on gas concentrations and/or airborne particulates via Bluetooth, WI FI or the like. The data may be transmitted to controller 208 for subsequent upload to UAV, as described above. Alternatively, UAV 100 may comprise a receiver (not shown) for directly receiving data transmissions from sensors 302. In this latter embodiment, for example, UAV 100 may be directed or pre-programmed to fly to a location near each of the sensors 302 to receive data transmission, e.g., Bluetooth, from the sensors 302. In yet another alternative embodiment, sensors 302 may include a digital or analog display of data regarding selected gases and UAV 100 may capture an image of the display for storage and/or transmission to external processor 200.

UAV 100 may further include a magnetic field generator (not shown) coupled to flight controller 110 for calibrating sensor(s) 302. In this embodiment, the magnetic field generator may be used as a “magnetic wand” to recalibrate sensors and/or to change the alarm settings for certain sensors.

For example, a sensor may be set to produce an alarm when hydrogen sulfide levels reach a certain assumed critical level. However, in certain locations and environments, the assumed critical level may fall within normal operating parameters. UAV 100 is configured to constantly monitor these levels and to recognize when the critical level should be changed to mitigate false alarms.

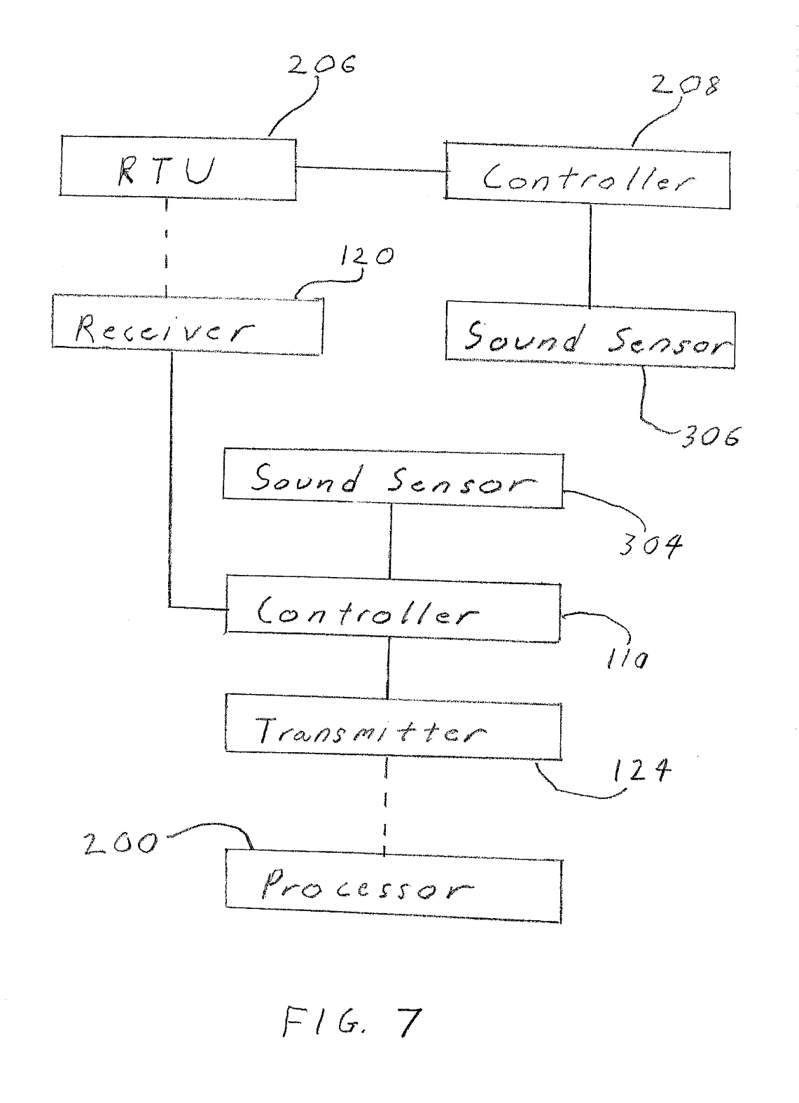

Referring now to FIG. 7, another embodiment of the present invention provides the UAV 100 with the ability to listen to certain equipment at the remote site and to transfer audio files to the external processor 200 and/or operator. Preferably, one or more sound sensors) 204 are mounted on body 102 of UAV 100. These sound sensors 304 are coupled to a sound recorder (not shown) configured to record sounds onto an audio file (also not shown), store the audio file and transmit the audio file to flight controller 110. Alternatively, the sound may be transmitted directly to digital storage 122 and/or flight controller 110, where it is then stored on an audio file. UAV 100 may further comprise digital or analog ambient noise filters coupled to sound sensors 304 or the sound recorder and designed to filter out certain sounds, such as noise from the rotors 104, or other ambient background noise that would detract from the desired recording. Flight controller 110 is designed to either make decisions based on the contents of the audio file and/or to transmit the audio file to external processor 200. For example, sound sensors 304 may be designed to detect sounds emanating from a pump at the well site. The system and/or operator can listen to the audio file of the pump noises to determine if the pump is operating within prescribed parameters. In this embodiment, UAV 100 will be automatically programmed, or manually directed, to fly adjacent to or near the relevant equipment (e.g., the pump) so that sound sensors 304 may pick up the sound emanating from the equipment.

Alternatively, and/or additionally, one or more sound sensors 306 may be located at various locations around the remote site, e.g., on the pump itself. In this embodiment, sound sensors 306 may be coupled to remote transmitter 206 (either directly or through controller 208) such that the detected sound is recorded to audio files, stored and transmitted to UAV 100. Sound sensors 306 may be hardwired to controller 208 or they may be wirelessly coupled through Bluetooth, WI FI or the like.

In this embodiment, sounds sensors 306 each comprise their own sound recorder so that a recorded audio file may be wirelessly transmitted to the remote controller 208. Similarly, the audio file may be transmitted directly to UAV 100 (i.e., bypassing controller 208 entirely). In this latter embodiment, UAV 100 comprises a receiver (not shown) for picking up the Bluetooth or WI FI signal from each sound sensor 306. In this manner, UAV 100 may collect data from sound sensors 306 in remote areas that do not have a controller 208 or an RTU 206. Suitable technology for detecting and transmitting sound recordings via Bluetooth is known by those skilled in the art, such as the Littman® Model 3200 electronic stethoscope, manufactured by 3M Company of Maplewood Minn., which can be suitably modified for use with the present invention.

In another embodiment of the invention, UAV 100 comprises a transponder (not shown) for transmitting ESRI standard or other geo-coded location data of the UAV 100 to third parties, such as FAA flight controllers. In addition, UAV 100 comprises collision avoidance software within flight controller 100 that will automatically redirect UAV 100 if and when it comes close to other flying objects or if its directed flight pattern will ultimately bring it close to other flying objects, such as airplanes, helicopters and other UAV's and/or structures, such as cell towers, tall buildings, mountains, power lines and the like. Navigation information regarding crash avoidance can be directed either to flight controller 110 or external processor 200 for purposes of adjusting the existing configuration (i.e., position and directional movement) of the peer to peer network of UAVs. UAV 100 may further comprise altitude limiting software within flight controller 100 that ensures that UAV 100 does not fly outside a prescribed range of altitudes (e.g., below 400 feet as is currently regulated by the FAA). UAV 100 may also include an application that automatically directs UAV 100 back to base when its power falls below a critical level. This critical level will constantly be updated by software within flight controller 100 and/or external processor 200 as it will depend on the location of UAV 100 relative to its base. This feature ensures that UAV 100 will not run out of power while flying and fall out of the sky. In other embodiments, UAV 100 comprises lockdown software within flight controller 110 that interrupts the directed-dispatch instructions of UAV 100 if it is about to run out of power, and instead, redirects UAV 100 to come to a slow and soft landing in an area that does not include a man-made object, such as a building, street, vehicle or the like.

In yet another embodiment of the invention, a plurality of UAVs 100 are used to monitor and collect data from a plurality of remote sites. Each of the UAV s 100 will, for example, be programmed to fly to certain sites at certain times of the day and collect data there from. In addition, external processor 200 will include software that keeps track of the location of all of the UAV's 100 during their programmed flights. In the event that the operator wishes to send a UAV 100 to a particular site on-demand (e.g., if a suspected failure has occurred that must be immediately checked), software within external processor 200 is configured to locate the UAV that is closest to the particular site and redirect that UAV from its programmed flying pattern to move to that particular site. In such instance, the anti-collision software on each of the UAV's prevents collisions that may otherwise occur with sudden changes in flight patterns that were not pre-programmed by the operator or the external processor 200.

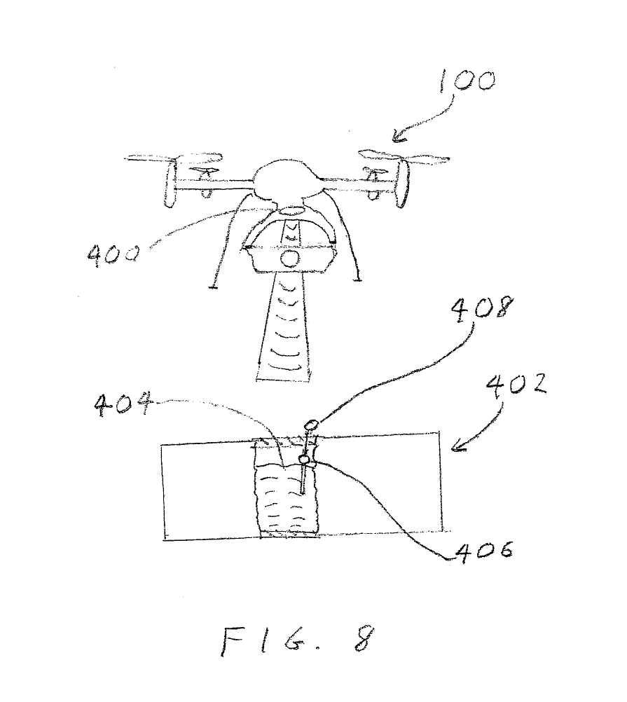

Referring now to FIG. 8, yet another embodiment of the present invention comprises one or more transmitter(s) 400 located on body 102 of UAV 100 and configured to transmit waves to an object containing a fluid for the purposes of measuring the level and/or properties (e.g., oil content) of the fluid within the object. In one embodiment, transmitter 400 comprises a wave transmitter designed to emit microwaves, light waves (e.g., infrared light), laser or the like for measuring fluid levels and/or properties within an object, such as a storage tank 402. In one example of the use of this embodiment, UAV 100 is dispatched to a remote site comprising one or more fluid tanks 402 that contain an unknown quantity or quality of a fluid 404. For example, in certain oil and gas refineries and wells, produced water, such as fracking waste fluid and the like, is generated over time within storage tanks in a non-linear and sometimes unpredictable manner. Produced water and/or fracking fluid in particular must be monitored closely by operators as it represents a potential environmental hazard. Typically, operators are required to physically inspect the storage tanks on a regular basis to ensure that the level of the produced or waste fluid is within safe parameters.

With the present invention, UAV 100 may be dispatched to a location near the storage tank(s) such that transmitter 400 is able to determine these levels and transmit this data to flight controller 110. UAV 100 may be further configured to provide instructions to a remote transmitter and/or controller at the refinery to change operating parameters based on the properties or level of the fluid. Alternatively, UAV 100 may relay the data with transmitter 124 to external processor 200 and/or user input 202.

Alternatively, the present invention may comprise a float sensor 408 residing within storage tank 402 and floating on fluid 404. One suitable float sensor that can be used with the present invention is the Gems Alloy Float Level Sensor, manufactured by Gems Sensors and Controls of Plainville, Conn., although those of skill in the art will recognize that other commercially available fluid level sensors may be used in conjunction with the present invention. Float level sensor 406 determines the level of fluid 404 within storage tank 402. In some embodiments, float level sensor 406 comprises a transmitter 408 that allows sensor 406 to transmit data on the fluid levels via Bluetooth, WI FI or the like. The data may be transmitted to controller 208 at the site, where it will then be picked up by UAV 100 during normal data collection procedures, as described above. Alternatively, float level sensor 406 may be directly or indirectly hardwired to RTU 206 or controller 208 for direct transmission of fluid level data. In other embodiments, UAV 100 comprises an antenna or receiver (not shown) for receiving signals or data from float transmitter 408 and may be programmed to fly near float level transmitter 408 for such purpose. In yet other embodiments, float level sensor 406 may have a simple digital or analog display of the float level that is coupled to sensor 406 and mounted outside of the storage tank. In these embodiments, UAV 100 may be programmed to fly near the display and capture an image of the digital or analog data that indicates the level of the fluid. This image may then be stored and transmitted to flight controller 110 for further processing (e.g., decision making) and/or relayed back to external processor 200 for analysis by the operator.

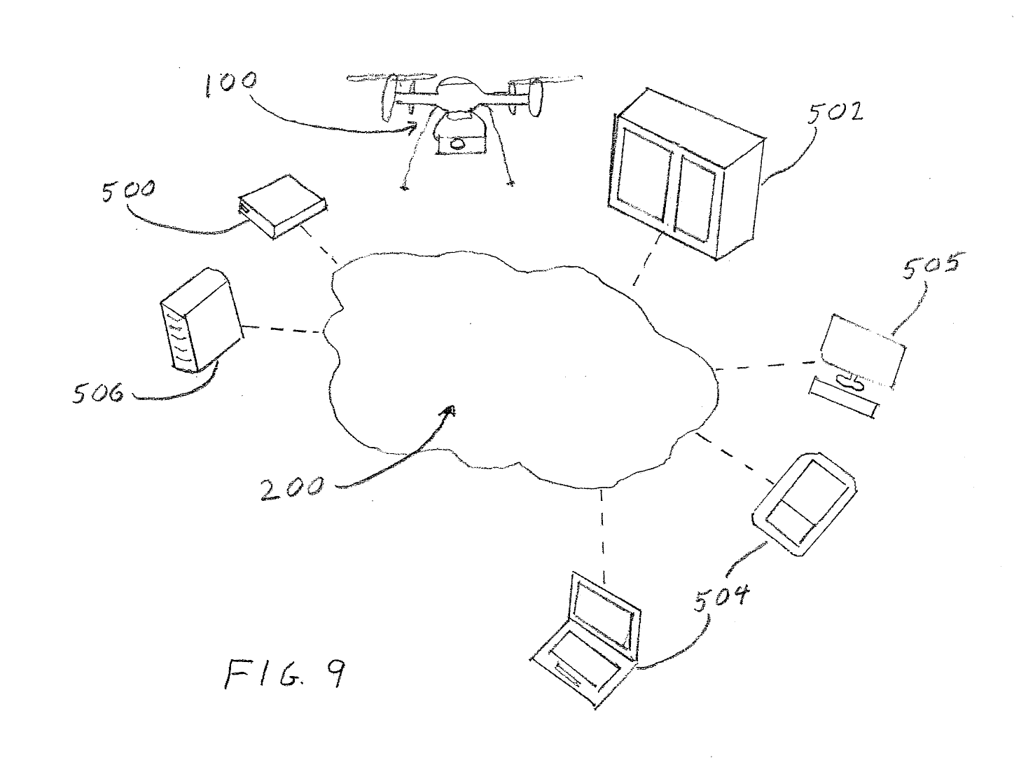

Referring now to FIG. 9, an exemplary method for collecting data from remote sites will now be described. UAV 100 is automatically and routinely dispatched to a plurality of remote oil and/or natural gas sites and refineries by external processor 200, which may comprise one or more server-based systems that utilize automated dispatched service application(s) 500 and GPS and telemetry applications 506. Alternatively, UAV 100 may be dispatched or controlled directly by the user, via a user-directed dispatch application 505 coupled to one or more input devices, 504, such as a mobile phone, computer, tablet or the like, to confirm a non-functioning or inadequately functioning well and/or to identify the causes of failure at a remote site (e.g., visual and/or audio confirmation of pump failure). The method typically employs a combination of server-based programs, on-board computer application(s) and UAV(s) 100 to rapidly and cost-effectively move to each of the oil and natural gas sites or refineries, gather significant data 502 from these sites and transmit that data 502 to the external processor so that the operator is immediately aware of the operational status of the site and any potential or actual failures. UAV 100 may perform multi-faceted verification of general operation parts, tank levels or well status at remote well sites, collection of other detailed well data or image capture. This data, video and photos 502 are collected for subsequent upload to central server(s) and/or cloud computing apparatus (es) 200 for eventual transmittal and display to one or more user input devices 504.

Preferably, processor 200 provides dispatch instructions that cause UAV 100 to fly to a particular remote site, collect data from that site, and then fly to another remote site and repeat the process. Once UAV 100 has completed data collection from all of the sites on its route, it will return to base. At a particular site, UAV 100 will fly to designated locations around the site and capture images of those locations to send back to external processor 200. These images enable the operator to view the remote site in almost real-time to determine if the well is operating properly. Historical reporting and trend analysis may also be performed on the collected data for purposes of anticipating part failures, adjusting parts, adjusting inventories and other reporting functions. While UAV 100 is on-site, digital receiver 120 will establish a WI FI connection with remote transmitter 206 and upload all data generated by controller 208 at the site.

This data may optionally include airborne particulates in the ambient environment around the well site, toxic gas concentrations, fluid levels and/or properties within storage tanks and/or audio files of sounds emanating from selected equipment at the site. Alternatively, UAV 100 may be directed to fly to selected locations around the remote site to directly gather these data through sensor(s) 300 and/or microphone(s) 304 located on UAV 100 or at selected locations around the remote site (i.e., wirelessly, image capture of data displays or the like).

UAV 100 transmits the collected data from the well site to external processor 200 through any of a variety of signal transmissions (cellular, microwave, radio, etc.), preferably in real-time. If there is no signal transmission available at the remote site, UAV 100 stores the data and then transmits when it has moved away from the remote site to an area where such signal is available. Alternatively, UAV 100 may transmit the data to another UAV located nearby which can eventually relay the data back to the external processor or cloud telemetry.

UAV 100 may make decisions based on the data gathered at each of the remote sites. These decisions may be translated into instructions, commands or data that is transmitted to the remote site (e.g., via remote transmitter 206) while UAV 100 is on-site to change operating parameters at the well site. Alternatively, UAV 100 may relay the data to processor 200 and wait for instructions or data from the processor, which may be sent automatically or manually directed by an operator viewing the data on user input 202. The data being transmitted may be 4-20 mA analogue signals or Modbus data originating from a local TCP or RS 232 connection, Modbus data directly from the RTU, PLC (Programmable Logic Controller) or other SCADA-based data transmitted to an RTU or Ethernet or any other type of remote transmitter configuration that is currently, or could be, used at remote sites, such as oil and gas wells, refinery and processing plants, windmill farms, coal mines, pipelines, nuclear reactors, research stations, manufacturing production lines or the like. In general terms, the data may include, but is not limited to, well input data, pump controller data, airborne particulate data, toxic gas concentrations, certain load and other calculated results, tubing and casing pressures, pump and plunger calculations, produced water and other tank level indicators, fluid properties (e.g., oil content), pump stroke, load, capacity, rpm, oil and water gravity readings, temperature and other fluid properties, torque analysis, energy consumption, rpm of meter with magnetic pickup, strokes per minute with magnetic pickup, voltage and amperage from an electrical control box adjoined to a POC, various pressure sensors, including tubing and casing located at the wellhead, chemical and fluid levels to various storage tanks, audio files or sounds emanating from equipment, such as pumps and other routine readings.

In another aspect of the invention, systems and methods are provided for collecting data at oil refinery and processing plants or other remote sites that generate toxic gas or other airborne gases or particulates. In addition to the above tasks, UAV 100 comprises one or more sensor(s) 300 configured to detect toxic gas concentrations or other airborne particulates in the ambient environment. In this embodiment, UAV 100 is dispatched to the site and flown to selected locations around the site that may contain concentrations of toxic gas. Sensor(s) 300 detect the amount of toxic gas at these locations and transfer this data to flight controller 110. Alternatively, sensors 302 may be located at selected locations around the remote site for detecting toxic gas concentrations. In this latter embodiment, sensor(s) 320 may be equipped with a transmitter (e.g., Bluetooth, WI FI or the like) to directly transmit data to UAV 100 or to the remote site's RTU 206 for capture by the data receiver onboard UAV 100. Alternatively, sensors 302 may be directly or indirectly hardwired to RTU 206 via controller 208. In yet another alternative, sensors 302 may comprise a visual display of data that is captured by camera 106 on UAV 100.

In another embodiment of the present invention, systems and methods are provides for collecting data from components or parts of a machine in a manufacturing production line. In this embodiment, a plurality of UAV's 100 each comprise one or more image capture devices designed to quickly capture images of parts on a production line. The UAV's are configured to hover at a selected location on the production line and to capture image of each part as it passes by the UAV. The UAV's further comprise one or more transmitters for transmitting the images to an external processor for analysis and decision making (e.g., whether the part has flaws).

Alternatively, the analysis and decision making may be made by a controller or processor on the UAV. The image capture device in this embodiment may be any of the devices previously described or more advanced devices, such as the artificial retina developed by engineers from the Imperial College London (e.g., “the bionic eye”). Such an artificial retina is capable of capturing only those moving elements essential for computer processing, which is then used to produce a video stream that can be transmitted to a display.

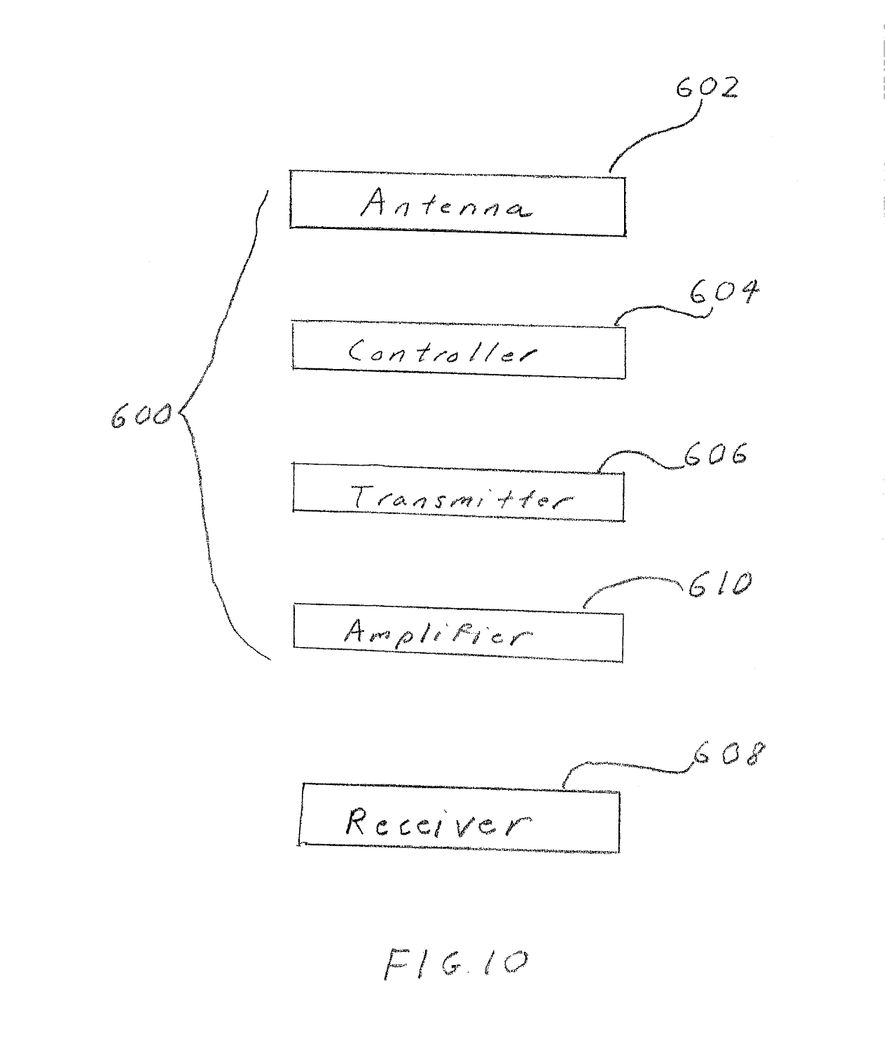

FIG. 10 is a flowchart illustrating yet another alternative embodiment of the current invention. In this embodiment, UAV 600 is used in remote areas where signal coverage is inadequate or completely absent. UAV 600 comprises one or more antennas 602 for receiving cellular, internet, intranet, VPN, television or other signal transmissions and/or data from sources 604, such as mobile phones, computers, televisions or the like. UAV 600 further comprises one or more transmitters 606 for transmitting or relaying these signals or data to an external receiver 608, such as a cell tower, satellite or the like. Thus, UAV 600 acts as a mobile cell tower, WI FI hotspot or satellite dish to relay signal transmissions or data that would otherwise be too weak to reach external receiver 608. In certain embodiments, UAV 600 may comprise a signal amplifier 610 for amplifying the signal transmission to extend the distance in which they may be transmitted from UAV 600 to the external receiver 608.

In certain extremely remote areas, signal amplifier 610 may not be sufficient to transmit all of the data or signal transmissions in a timely fashion to external receiver 608. In such event, the present invention provides a peer-to-peer network comprising a plurality of UAVs 600 configured to relay data or signal transmission to each other until the data or signal transmission can reach the external receiver 608. In this embodiment, each UAV 600 preferably comprises software applications (not shown) enabling UAV 600 to search for external receiver 68 and/or another UAV 600. These software applications will cause UAV 600 to transmit the data or signal transmission to, for example, another UAV 600 or signal repeater positioned in a different location. This transmission from UAV to UAV will continue until one of the UAV's locates external receiver 608. In this manner, the peer-to-peer network can relay data or signal transmission from sources 604 to external receiver 608 in remote areas where signal coverage is limited or completely unavailable.

In another aspect of the invention, a system comprises a plurality of UAVs each having one or more video cameras, such as the one shown in FIG. 2, and a flight controller configured to store still or video images taken by the video camera(s) into data files. The system further comprises a central processor, server(s), cloud(s) or the like capable of assigning IP addresses to each of the UAVs and connected to the internet or world wide web through a standard HTTP or FTD protocol or the like. The UAVs may also each have physical locations (e.g., the corner of 42nd and Broadway) or they may have physical areas in which they patrol or move around (e.g., the border between two countries). The central processor is configured to locate a UAV based on either its IP address or its physical address. In this embodiment, a user having an input device may connect directly to one of the UAVs by searching an IP or physical address through the central server. Thus, the user may be able to download stored or live video files from the flight controller of the UAV onto his/her own user input device, e.g., mobile phone, computer, tablet or the like. Alternatively, the user may be able to view the video taken by the image capture device on the UAV in real-time by dialing up the IP or physical address of a particular UAV and being directed to the flight controller of the UAV.

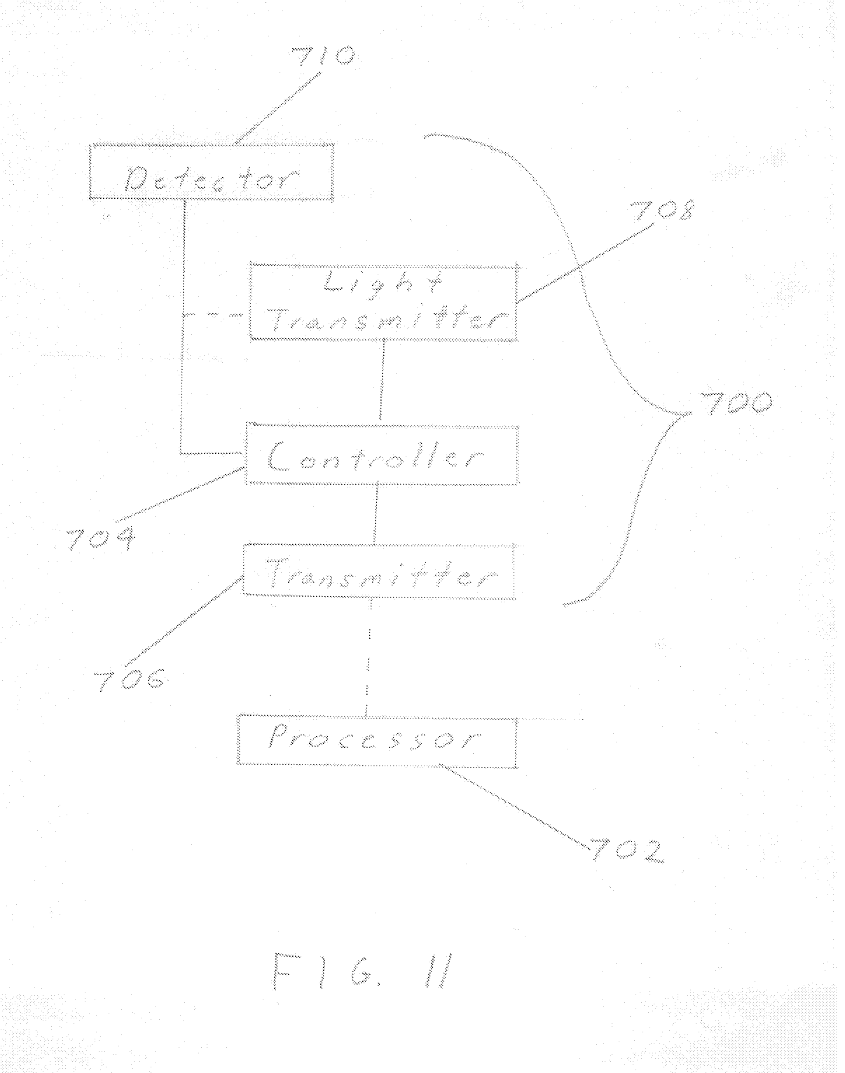

In another embodiment of the invention, systems, methods and devices for detecting objects, particulates, molecules, gases, ground-based elements or compounds, and/or weather conditions are described with reference to FIG. 11. As shown, the system comprises a UAV 700 having one or more transmitters or antennas 706 coupled to an external processor 702, such as a telemetry cloud, SPL or other external processor via WI FI, cellular, radio, satellite, microwave or other suitable signal transmissions. In one preferred embodiment, UAV 700 further comprises one more light transmitter(s) 708 configured to transmit a programmed pattern of light beams into the ambient environment around a remote site, such as an oil or natural gas plant, pipeline or storage facility. Light transmitter(s) 708 are coupled to a controller 704, which can be the flight controller 110 described previously, or a distinct controller designed for the purposes of this embodiment. UAV 700 may further comprise one or more detectors 710 coupled to controller 110 for detecting reflected and/or backscattered light in the ambient environment. Alternatively, detectors 710 may be integral with light transmitter(s) 708 and/or controller 704.

In a preferred embodiment, light transmitter(s) 708 comprise lasers, such as diode lasers or the like, mounted to body 102 of UAV and designed to transmit a programmed pattern of coherent light beams into the ambient environment around UAV 700. Light transmitter(s) 708 may be rotatably coupled to body 102 of UAV 700 such that the direction of transmission of the light beams can be varied relative the orientation of the UAV 700. Alternatively, light transmitters 708 may be fixedly mounted to body 102 and the UAV 700 may rotate to control the direction of light transmission. Light transmitters 708 may be automatically actuated by flight controller 110 based on GPS coordinates that have been pre-programmed into controller 704. Alternatively, light transmitters 708 may be controlled directly by external processor 702 and/or the operator based on pre-specified GPS coordinates or simply by viewing the UAVs 700 location through image capture device 106.

Light transmitter(s) 708 preferably emit laser beams at a specified frequency or wavelength to detect the presence, concentration of and/or velocity of certain molecules, particulates or gases in the environment around the UAV 700. In an exemplary embodiment, transmitter(s) 708 comprise a LIDAR (Light Detection and Ranging) system, wherein light beams are scattered and attenuated by molecules, aerosols (e.g., dust) and cloud (particle or ice) particles in the atmosphere. The LIDAR system uses laser pulses to measure atmospheric constituents around the remote sites, such as water vapor, ice crystals, aerosol particles or trace gases from industrial emissions, such as methane, hydrogen sulfide, hydrocarbons and the like.

In one such embodiment, light transmitter(s) 708 comprise a Raman LIDAR system that detects scattering of the laser beams though Raman scattering. The frequency shift induced by such scattering is unique for each molecule and creates a “signature” to identify the presence of the molecule in the ambient environment. When UAV 700 has been moved into position at the remote site, light transmitter(s) 708 emit the laser beams into the ambient environment around the site and detector(s) collect the backscatter from the beams. Controller 704 analyzes the backscatter to determine the presence of the targeted molecules. Alternatively, the data from the backscattered light may be transmitted wirelessly to external processor 702 or other cloud apparatus for analysis.

In another embodiment, light transmitter(s) 708 comprise differential absorption LIDAR (DIAL), wherein two or more laser beams are emitted from UAV 700 with distinct frequencies or wavelengths. One of the laser beams is substantially tuned to a wavelength or frequency that is not expected to have substantial molecular absorption in the ambient environment around the remote site; i.e., a control beam. One or more of the other laser beams are tuned to a wavelength or frequency that is tuned to a target particulate or gas; i.e., target beam(s). The control beam and the target beam(s) are transmitted into the air around the remote site and the detector 710 senses and quantifies the backscatter from the beams. The controller 704 compares the backscattered light from the control beam and the target beam(s) to determine the presence of, and/or the concentration of, the targeted particulate or gas in the ambient environment. Alternatively, the data from the target and control beams may be wirelessly transmitted to external processor 702 for analyzing the backscattered light and determining the presence of the targeted substance.

In an exemplary embodiment, controller 704 further comprises a software application coupled to light transmitter(s) 708 and configured to vary the frequency and/or wavelength of the light beams. This allows UAV 700 to detect different particulates or gases having different absorption frequencies. The software application may be designed to automatically scroll through a pre-determined set of frequencies/wavelengths, or controller 704 may be configured to vary the frequencies based on the data collected on the first particulate or gas. Alternatively or additionally, the operator may change the frequency of the light beams in real-time by transmitting instructions through processor 702 to controller 704.

UAV 700 may also be used to detect the velocity and direction (i.e., velocity vector) of the airborne particulates, ground-based elements or compounds, molecules or gases by detecting the frequency shift of the backscattered light and using the optical Doppler effect (e.g., positive frequency shift indicating that the target molecule is moving towards the UAV and negative frequency shift indicating that the target molecule is moving away). Coherent and/or direct-detection techniques may then be used to measure the magnitude of the frequency shift and thus the velocity of the target molecules. In this manner, UAV 700 may detect wind speed and direction ad/or the speed and direction of any particulates or gases that have been released at the remote site. Controller 704 is configured to correlate this data and wirelessly transmit it to external processor 702. Processor 702 may then generate instructions to UAV 700, e.g., rerouting instructions and/or instructions to reposition UAV 700 at the remote site to gather more data on the concentration, location and/or velocity vectors of the particulates or gases. For example, UAV 700 may be instructed to move to selected positions around the remote site to gather particulate or gas concentration data at these positions. This data can then be analyzed by controller 704, external processor 702, another UAV, or the operator to determine an average concentration profile of the substances at the site and/or the areas where the substances are more highly concentrated.

Alternatively, UAV 702 may be moved downwind from its original position or the remote site to detect whether airborne particulates or gases have drifted with the wind from their original source (e.g., methane leaking from a pipeline and drifting downwind from the original source of the leak). In this manner, the system of the present invention is capable of very accurately determining if a particular substance is present at a remote site.

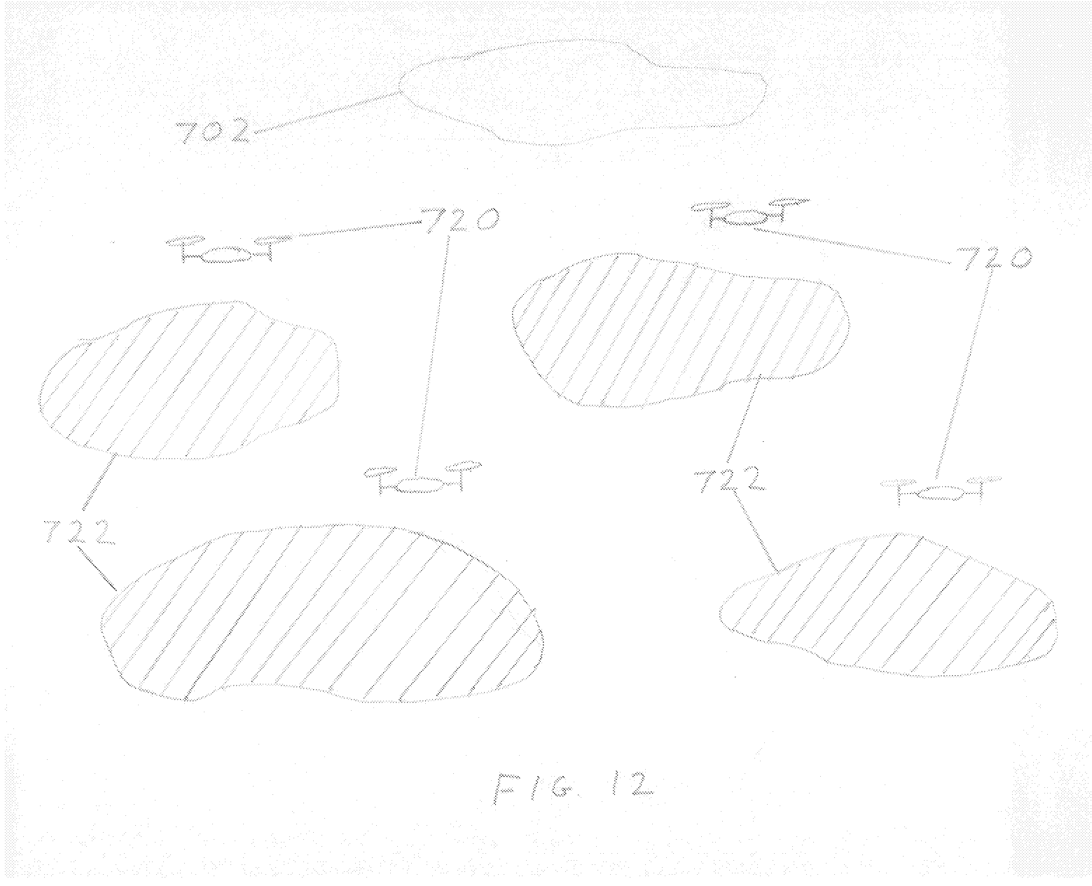

Referring now to FIG. 12, a substance detection system according to the present invention includes a plurality of UAVs 720 wirelessly coupled to a central external processor or cloud apparatus 702 for detecting and/or quantifying the location and concentration of a variety of different substances, such as particulates, molecules, gases or weather conditions over a large area that may include multiple remote sites 722. As shown, UAVs 720 are each wirelessly coupled to central external processor 702 for transmitting data collected at sites 722 to processor 702 and for receiving instructions from the processor 702.

In this embodiment, UAVs 720 are preferably configured to transmit data in real-time to external processor 702 which, in turn, analyzes the data and transmits updated information and/or instructions back to UAVs 720. This real-time feedback and updating system allows multiple UAVs 720 and central processor 702 to work in tandem to quickly and efficiently detect substances or weather conditions in very remote areas that would otherwise be impractical to search with conventional systems.

In one such embodiment, each UAV 720 comprises one or more sensors, such as the light transmitters described previously, for detecting a variety of weather, water current and/or tide conditions at each remote site and then transmitting this data to processor 702. In one such embodiment, processor 702 is configured to correlate this data and determine an overall weather pattern in the larger area, including actual or potential weather conditions based on wind, humidity, air pressure differences in different areas or altitudes, the actual or potential presence of precipitation, cloud vapor, ice or other key variables at the various remote sites. Preferably, processor 702 is configured to automatically change the navigation of one more UAVs 720 to reroute these UAVs based on the weather conditions in the area. Alternatively, processor 702 may transmit the weather data to a user for manual rerouting of the UAVs 720. For example, processor 702 may cause one or more UAVs 720 to return to its base due to actual or potential adverse weather conditions, such as icing, tornado, lightning, high winds, snow, rain or the like. Alternatively, processor 702 may optimize route conditions based on rain, wind or other weather conditions. For example, an individual UAV 720 may be rerouted to move to the remote area of another UAV if the flight route of the latter UAV 702 would cause it to fly through adverse weather conditions, thereby optimizing the collection of data at these sites based on weather conditions. In an exemplary embodiment, UAVs 720 at different altitudes may detect barometric pressure in combination with temperature readings at these different altitudes to predict potential storm formation conditions in the area and the optimize UAV routing based on these predictions. Processor 702 may also transmit weather advisories to the operator to warn operators of actual or potential weather conditions at certain remote sites or along the routes between such sites.

In another embodiment, UAVs 720 may be used to determine water current and/or tide conditions in bodies of water, such as lakes, rivers and oceans. In combination with the detection of weather conditions, this data is wirelessly transmitted to processor 702, which correlates the data to determine optimum shipping, sailing, fishing or other nautical conditions or locations in the bodies of water. The processor 702 may then redirect one or more the UAVs 720 to a more precise location where fishing conditions are optimal. The redirected UAV 720 may then use one or more detectors, such as the light transmitters previously described, to detect the presence and/or concentration of fish underneath the surface of the water.

In other embodiments, a method for pinpointing the specific location of a gas leak, such as methane, is carried out in a similar manner. UAVs 720 may be dispatched to a wider area that includes one or more remote locations 720, such as a large natural gas refinery, a plurality of storage facilities or along the length of a pipeline or a series of pipelines. When one of the UAVs 720 detects the presence of the targeted particulate, molecule or gas, it immediately transmits this information to processor 702. The UAV 720 may also measure the wind speed and direction in the area where the substance has been detected. This information is passed to processor 702, which then dispatches one or more UAVs 720 downwind of the initial target location to determine the location of the leak. Processor 702 will transmit GPS coordinates to the UAVs 720 and will also transmit instructions to search for the particular substance that was detected by the original UAV. For example, processor 702 may instruct the UAVs to change the frequency of the light transmitters to correspond to the absorption frequency of the detected substance (or processor 702 may automatically change that frequency itself through wireless transmission of instructions to the controller on each UAV).

The UAVs 720 continuously update processor 702 with data regarding the concentration of the targeted substance and any changing wind conditions and the processor 702 continuously uses this feedback to reroute the UAVs 720 to move to different locations corresponding to higher concentrations of the substance. With this feedback system of the present invention, the UAVs 720 will eventually pinpoint the exact location of the origin of the substance, e.g., a methane gas, water or oil leak in a section of a pipeline.

In yet another embodiment, each UAV 720 includes one or more image capture devices (not shown) capable of capturing images in multiple light spectral bands, i.e., multiple bands of light wavelengths or frequencies. In a preferred embodiment, the image capture device(s) capture images in at least four different spectral bands, including near-infrared, red-edge, red and green. UAV 720 and/or processor 702 further include a software application capable of analyzing the data captured by the image capture devices, such as a 16 Mp RBG sensor or the like. In this manner, both analytical data and visible imaging can be captured by each UAV 720 in the same flight (either directly by the UAV or through wireless feedback between the processor and the UAV). The data and images can be wirelessly transmitted to central processor 702 and the operator for analysis.

In certain embodiments, the multispectral data capture system on UAV's 720 is used according to the present invention to search a wider area for a variety of different airborne or ground level substances. In this method, pluralities of UAV's 720 are dispatched to specified search grids with GPS coordinates by processor 702 or directly by the operator. Each UAV 720 captures large-scale images of the search grid, either with a standard video or camera device, or with the multi-spectral image capture device of the present invention. If the captured images include an anomaly in one of the search grids that may represent a substance of interest, this data is transmitted wirelessly to the central processor and/or the operator for analysis to determine whether the images warrant further investigation and/or if a particular substance may be present within the area of the captured image (e.g., a “spill cone” representing a possible contaminated area or other safety concern). The GPS coordinates of the target area may then be compared against an available drone deployment coverage map and the processor and/or the operator makes a decision as to which drones should be sent to or around the target area. This decision may be made automatically with logic-based software in the processor, or the operator may view the data and make this decision manually.

Once a decision to follow up on the anomaly has been made, the processor and/or operator transmits instructions to one or more of the UAV's 720 that include navigation instructions for moving to the target location within the target area or “spill cone.” These instructions may also include instructions to search for a particular set of substances (e.g., calibrate the LIDAR sensors on the UAVs to search for a subset of possible contaminants, hydrocarbons or airborne particles within the target area). Upon receiving these instructions, the UAV's 720 move to the new GPS coordinates and activates light transmitters 708 to detect the substances. Processor 702 may also send instructions to the UAV's to determine the concentration of the targeted substance and/or the wind speed or other weather conditions that may be relevant to the search. The data received by the UAV's is continuously relayed back to the processor 702, which continuously updates its analysis and sends out further instructions based on this feedback to allow one or more UAV's to pinpoint the location and concentration of the substances in the target area. Thus, the two systems of the present invention (multispectral image capture and laser detection) can be used in conjunction to more effectively and efficiently detect airborne particulates and gases in remote locations.

In another embodiment of the present invention, the multispectral data capture system on each UAV 720 are used to search for substances on or under the surface of the ground, such soil or plant conditions (e.g., to optimize water irrigation), hydrocarbons associated with oil underneath the ground, minerals, precious metals and the like. In this method, one or more UAVs 720 are moved to potential search areas, where they capture images of the ground in multiple light spectral bands, as discussed previously. The data captured from the multiple light spectral bands is then wirelessly transmitted to processor 702 and/or the operator for analysis. Similar to the above embodiments, processor 702 may then send GPS coordinate instructions to UAVs 720 to move to a new location to gather more information on the potential presence of these substances on or underneath the ground surface. For example, UAVs 720 may move to a selected search location and activate one or more light transmitters to search the ground directly for particulate molecules or substances (e.g., hydrocarbons indicating the presence of oil) or they may search for substances associated with other substances underneath the ground. For example, certain metals or minerals under the ground may change the composition of the soil above them. In this instance, the UAV will search for molecules or substances associated with the changed soil composition that may indicate the presence of a particular metal or mineral underneath the ground at that location.

In yet another aspect of the invention, each UAV 720 comprises one or more sensors (not shown) for detecting the presence of other unauthorized UAVs in the immediate area. Preferably, these sensors are configured to detect radio control transmissions from the unauthorized UAVs. UAVs typically transmit at radio or microwave frequencies between about 27 MHz to about 6 GHz, with the most common frequencies being around 433 MHz and 2.4 GHz. The sensors may also be configured to detect wireless video feed (e.g., HD WI FI) that is typically transmitted from UAVs.

Each UAV 720 is configured to transmit this data regarding the presence of unauthorized UAVs in a certain area to external processor 702. External processor 702 includes a logic-based software application interpreting the data received from the UAV and confirming whether or not the intercepted transmission was, in fact, sent from an unauthorized UAV. Once the processor 702 has made this confirmation, another software program transmits instructions to UAVs 720 to interrupt or cease the GPS transmission of the unauthorized UAV. Once UAV 720 receives these instructions, it transmits a jamming frequency towards the targeted UAV to jam its GPS transmission, forcing the other UAV to return to its base (all commercial UAVS are programmed to return to base in the absence of GPS coordinate instructions). This embodiment may be used in a variety of security situations to create an airborne “geofence” around critical or confidential areas, such as airports or airspaces around airports, stadiums, government buildings, private corporate facilities and the like.

Although the invention herein has been described with reference to particular embodiments, it is to be understood that these embodiments are merely illustrative of the principles and applications of the present invention. It is therefore understood that modifications may be made to the illustrative embodiments and that other arrangements may be devised without departing from the spirit and scope of the invention as defined by the appended claims.

1. A system configured for collecting data from a remote site comprising:
an unmanned aerial vehicle configured to move to a remote site;
one or more sensors located on the unmanned aerial vehicle and configured to detect particulates, molecules or gases at the remote site; and
a processor wirelessly coupled to the unmanned aerial vehicle, wherein the unmanned aerial vehicle is configured to wirelessly transmit data related to the particulates, molecules or gases to the processor.

2. The system of claim 1 wherein the one or more sensors comprise a light transmitter configured to transmit light at a specific frequency into an ambient environment at the remote site and a light detector configured to detect backscatter from the transmitted light.

3. The system of claim 2 wherein the light transmitter comprises a laser configured to transmit laser pulses at the specific frequency.

4. The system of claim 2 wherein the specific frequency is tuned to an absorption characteristic of an airborne particulate or gas.

5. The system of claim 4 further comprising a software program coupled to the one or more sensors and configured to vary the specific frequency of the one or more sensors to vary the airborne particulate or gas detected by the one or more sensors.

6. The system of claim 1 wherein the one or more sensors are further configured to detect a velocity vector of the particulates, molecules or gases.

7. The system of claim 1 wherein the one or more sensors are configured to detect a weather condition of an ambient environment at the remote site, wherein the weather condition is selected for a group comprising wind, precipitation and humidity.

8. The system of claim 1 further comprising a software program configured to receive dispatch information from the processor and to move the unmanned aerial vehicle to a plurality of selected locations around the remote site based on the dispatch information.

9. The system of claim 7 further comprising further comprising a logic-based application configured to analyze a weather condition or the particulates, molecules or gases collected from the remote site and to make a decision based on the weather condition or the particulates, molecules or gases.

10. The system of claim 9 further comprising a command application coupled to the logic-based application and configured to transmit instructions to the unmanned aerial vehicle based on the decision of the logic-based application.

11. The system of claim 10 wherein the instructions include instructions to move the unmanned aerial vehicle to one or more selected positions around the remote site based on the weather condition or the detection of the particulates, molecules or gases.

12. The system of claim 1 wherein the particulates, molecules or gases comprises methane gas.

13. The system of claim 1 wherein the particulates, molecules or gases are selected from a group comprising hydrogen sulfide, hydrocarbons, ammonia, carbon monoxide, carbon dioxide, arsine, phosphine, hydrogen cyanide, sulfur oxide, oxygen and radioactive particles.

14. The system of claim 1 wherein the one or more sensors are configured to detect molecules on or under a surface of the ground at the remote site.

15. The system of claim 14 wherein the molecules include hydrocarbons, minerals or metals.

16. The system of claim 1 further comprising an image capture device configured to capture images in multiple light frequencies or wavelengths.

17. The system of claim 1 wherein the image capture device is configured to capture images from a group of light wavelengths comprising near-infrared, red-edge, red and green.

18. A method for collecting data from a remote site comprising:
moving an unmanned aerial vehicle to the remote site;
detecting particulates, molecules or gases at the remote site, via the unmanned aerial vehicle; and
wirelessly transmitting data related to the particulates, molecules or gases from the unmanned aerial vehicle to a processor located remotely from the remote site.

19. The method of claim 18 wherein the detecting step is carried out by transmitting light at a specific frequency from the unmanned aerial vehicle into an ambient environment around the remote site and detecting backscatter from the light with the unmanned aerial vehicle.

20. The method of claim 19 further comprising transmitting laser pulses at a specific frequency from the unmanned aerial vehicle into the ambient environment around the remote site.

21. The method of claim 20 further comprising tuning the laser pulses to a frequency associated with an absorption characteristic of a first airborne particulate or gas.

22. The method of claim 21 further comprising varying the frequency to match the absorption characteristic of a second airborne particulate or gas.

23. The method of claim 18 further comprising detecting a weather condition of an ambient environment around the remote site, the weather condition being selected from the group comprising wind, precipitation and humidity.

24. The method of claim 23 further comprising wirelessly transmitting the weather condition to the processor and relaying the weather condition to an operator remotely located from the processor.

25. The method of claim 23 further comprising moving the unmanned aerial vehicle to one or more different positions around the remote site based on the weather condition or the data related to the particulates, molecules or gases and detecting the particulates, molecules or gases at the one or more different positions.

26. The method of claim 18 further comprising detecting, via the unmanned aerial vehicle, a velocity vector of the particulates, molecules or gases.

27. The method of claim 25 wherein the moving step is carried out by:
analyzing, via the unmanned aerial vehicle, the weather condition or the data related to the particulates, molecules or gases detected by the unmanned aerial vehicle;
making a decision, via the unmanned aerial vehicle, based on the weather condition or the data related to the particulates, molecules or gases; and
moving the unmanned aerial vehicle to one or more different positions based on said decision.

28. The method of claim 18 wherein the particulates, molecules or gases comprises methane.

29. The method of claim 18 wherein the particulates, molecules or gases is selected from a group comprising hydrogen sulfide, hydrocarbons, ammonia, carbon monoxide, carbon dioxide, arsine, phophine, hydrogen cyanide, sulfur oxide, oxygen and radioactive particles.

30. The method of claim 18 further comprising detecting, via the unmanned aerial vehicle, molecules on or under a surface of the ground at the remote site.

31. The method of claim 30 wherein the molecules are hydrocarbons, minerals or metals.

32. The method of claim 30 further comprising capturing images on or under the surface of the ground in multiple light spectrums, via the unmanned aerial vehicle, prior to the detecting step.

33. The method of claim 32 wherein the multiple light spectrums are selected from the group comprising near-infrared, red-edge, red and green.
